(19) United States
(12) Patent Application Publication
(10) Pub. No.: US 2009/0231262 A1
(43) Pub. Date: Sep. 17, 2009

(54) SPREAD SPECTRUM CLOCK GENERATOR AND DISPLAY DEVICE USING THE SAME

(76) Inventor: Jin-Mo KWON, Asan-si (KR)

Correspondence Address: Haynes and Boone, LLP;IP Section, 2323 Victory Avenue, SUITE 700, Dallas, TX, 75219, US

(21) Appl. No.: 12/271,634

(22) Filed: Nov. 14, 2008

(30) Foreign Application Priority Data
Mar. 14, 2008 (KR) 10-2008-0023823

(51) Int. Cl. G09G 3/36; H04B 1/00

(52) U.S. Cl. 345/99; 375/138

(57) ABSTRACT

A spread spectrum clock generator and a display device having the same are disclosed. The spread spectrum clock generator includes: a spread spectrum clock generating circuit that receives a reference clock and generates a spread spectrum clock; and a modulation control circuit that provides a modulation control signal to the spread spectrum clock generating circuit, wherein the frequency of the spread spectrum clock is irregularly modulated by the modulation control signal. The spread spectrum clock is irregularly generated according to the modulation control signal.

### CROSS-REFERENCE TO RELATED APPLICATION

This application claims priority to, and the benefit of, Korean Patent Application No. 10-2008-0023823 filed in the Korean Intellectual Property Office on Mar. 14, 2008, the entire contents of which are incorporated herein by reference.

### BACKGROUND OF THE INVENTION

(a) Field of the Invention

The present invention relates to a spread spectrum clock generator and a display device having the same.

(b) Description of the Related Art

There are various types of display devices. Among them, display devices employing a liquid crystal display (LCD) panel are becoming increasingly common.

The liquid crystal panel is employed for almost every information processing device in need of a display device, and examples include not only small products such as mobile phones, personal digital assistants (PDAs), portable multimedia players (PMPs), and the like, but also midsize or large products such as monitors and TVs.

In addition, demand for high resolution display devices continues to increase. Here, the term high resolution implies an increase in the degree of integration, for which the wavelength of a driving frequency is becoming shorter. That is, the wiring length within a display device is being reduced to be as short as the wavelength of RF signals. This often results in generation of considerable electromagnetic waves within the display device, compromising the EMI characteristics of the display device at high clock frequencies and resulting in malfunctions and deterioration of image quality.

To solve this problem, a spread spectrum clock generator is often employed to modulate the clock frequency so as to reduce the generation of electromagnetic waves in the display device.

However, the clock frequency that is modulated by the spread spectrum clock generator also has a certain period, so if the modulated clock frequency overlaps with a pixel charge time or with a particular driving frequency, image quality of an image displayed on the display device can be degraded or a malfunction may occur.

The above information disclosed in this Background section is only to enhance understanding of the background of the invention and therefore it may contain information not deemed relevant prior art.

### SUMMARY OF THE INVENTION

The invention can be implemented in a number of ways, including as a device and as a method.

An exemplary embodiment of the present invention provides a spread spectrum clock generator including a spread spectrum clock generating circuit that receives a reference clock and generates a spread spectrum clock, and a modulation control circuit that provides a modulation control signal to the spread spectrum clock generating circuit, wherein a frequency of the spread spectrum clock is varied according to the modulation control signal.

Another embodiment of the present invention provides a display device including a spread spectrum clock generating circuit that receives a reference clock and generates a spread spectrum clock, and a modulation control circuit that provides a modulation control signal to the spread spectrum clock generating circuit, wherein a frequency of the spread spectrum clock is varied according to the modulation control signal.

Yet another embodiment of the present invention provides a method for generating a spread spectrum clock, including generating an irregular counter control signal; counting clocks according to the counter control signal so as to generate a modulation control signal; and generating a spread spectrum clock according to the modulation control signal.

### BRIEF DESCRIPTION OF THE DRAWINGS

FIG. 1 is a schematic block diagram of a spread spectrum clock generator according to a first exemplary embodiment of the present invention.

FIG. 2 is a schematic block diagram of a modulation control circuit in FIG. 1.

FIG. 3 shows wavesforms of a modulation control signal outputted from the modulation control circuit in FIG. 2.

FIG. 4 is a schematic block diagram of a display device according to a second exemplary embodiment of the present invention.

FIG. 5 is a schematic block diagram of a display device according to a third exemplary embodiment of the present invention.

FIG. 6 is a schematic block diagram of a display device according to a fourth exemplary embodiment of the present invention.

### DETAILED DESCRIPTION OF EMBODIMENTS OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

A liquid crystal display panel according to an exemplary embodiment of the present invention is illustrated as a display panel in the accompanying drawings, but the present invention is not limited thereto. Thus, the present invention can also be applicable to various other display panels such as organic light emitting diode display panels, plasma display panels, and the like.

In order to clarify the present invention, parts that are not connected with the description will be omitted, and the same elements or equivalents are referred to as the same reference numerals throughout the specification.

In describing the exemplary embodiments of the present invention, the same reference numerals are used for elements having the same constructions and that are representatively described in a first exemplary embodiment of the present invention, and in other exemplary embodiments of the present invention, only different constructions from those of the first exemplary embodiment will be described.

### Exemplary Embodiment 1

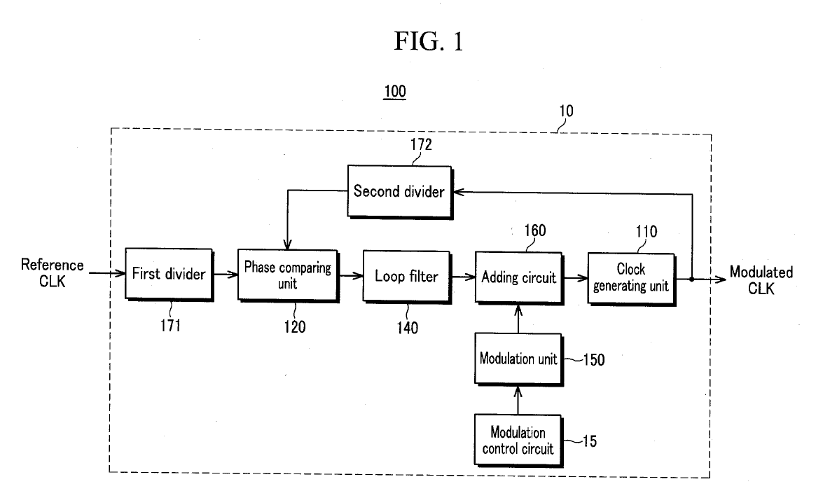

FIG. 1 is a schematic block diagram of a spread spectrum clock generator according to a first exemplary embodiment of the present invention.

As shown in FIG. 1, the spread spectrum clock generator 100 includes a spread spectrum clock generating circuit 10 and a modulation control circuit 15. The spread spectrum clock generating circuit 10 receives a reference clock and modulates the reference clock to generate a spread spectrum clock. The modulation control circuit 15 provides a modulation control signal to the spread spectrum clock generating circuit 10. Here, according to the modulation control signal, the spread spectrum clock generating circuit 10 generates an irregular spread spectrum clock.

The spread spectrum clock generating circuit 10 includes a modulation unit 150 and a clock generating unit 110. The spread spectrum clock generating circuit 10 further includes a phase comparing unit 120, a loop filter 140, an adding circuit 160, a first divider 171, and a second divider 172. However, the configuration of the spread spectrum clock generating circuit 10 is not limited thereto, and may be modified according to those of ordinary skill in the art.

The modulation unit 150 generates a spread spectrum modulation voltage according to the modulation control signal received from the modulation control circuit 15.

The clock generating unit 110 generates a spread spectrum clock according to the spread spectrum modulation voltage received from the modulation unit 150. Here, a voltage controlled oscillator (VCO) may be used as the clock generating unit 110.

The phase comparing unit 120 detects a phase difference between the reference clock and the spread spectrum clock, and outputs a phase difference voltage that is proportional to the detected phase difference.

The loop filter 140 receives an output voltage of the phase comparing unit 120, filters the voltage, and outputs a filtered voltage. The loop filter 140 may be a low-pass filter or an integrator.

The adding circuit 160 adds the spread spectrum modulation voltage generated by the modulation unit 150 to the filtered voltage output from the loop filter 140, and provides the resultant voltage to the clock generating unit 110.

The first divider 171 lowers the frequency of the reference clock by a first constant ratio, and the second divider 172 lowers the frequency of the spread spectrum clock by a second constant ratio. The first and second dividers 171 and 172 then transfer their lowered frequencies to the phase comparing unit 120. Here, the first and second constant ratios may be the same.

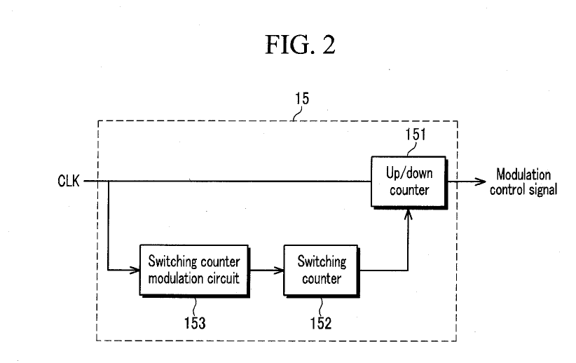

With reference to FIG. 2, the modulation control circuit 15 includes an up/down counter 151, a switching counter 152, and a switching counter modulation circuit 153.

The up/down counter 151 receives the divided clocks and counts them, and when the counted clocks reach a pre-set count value, the up/down counter 151 is switched from an up-counting operation to a down-counting operation or from a down-counting operation to an up-counting operation. For example, if a pre-set count value is 5, the up/down counter performs an up-counting operation five times, and then performs a down-counting operation. Namely, if up-counting starts at a first clock, the up/down counter 151 is switched to perform down-counting at a sixth clock.

The switching counter 152 provides the up/down counter 151 a count value that varies in a periodic manner (i.e., the count values vary according to a repeating pattern), with a specified minimum and maximum. Here, the “size” of the period refers to the number of count values included in a single such period. The count value refers to the number of clocks counted until the up/down counter 151 is switched between up-counting and down-counting. Here, the count value is a positive integer.

As one example, if the count values received are n+2, n+1, n, n+1, and n+2 where n=1, then the maximum value is 3, the minimum value is 1, and each period includes four count values. Thus, the count values are provided in the order of 3, 2, 1, 2, and 3 to the up/down counter 151. If up-counting starts, the up/down counter 151 starts up-counting at the first clock and is switched to perform down-counting at the fourth clock. Thereafter, the up/down counter 151 is switched to up-counting at a sixth clock and then switched to down-counting at a seventh clock. Then, the up/down counter 151 is switched to up-counting at a ninth clock and switched to down-counting at a twelfth clock.

The switching counter modulation circuit 153 changes one or more of the maximum value, the minimum value, and the period, in irregular fashion. Namely, the switching counter 152 may change the number of count values included in one period, as well as the maximum value and the minimum value. Thus, the switching counter 152, when governed by the switching counter modulation circuit 153, provides irregular count values to the up/down counter 151.

In the above description, the switching counter modulation circuit 153 did not modulate the switching counter 152, so that the switching counter 152 provided a count value that varied strictly periodically. In contrast, the following example illustrates a case in which the switching counter 152 is affected by the switching counter modulation circuit 153.

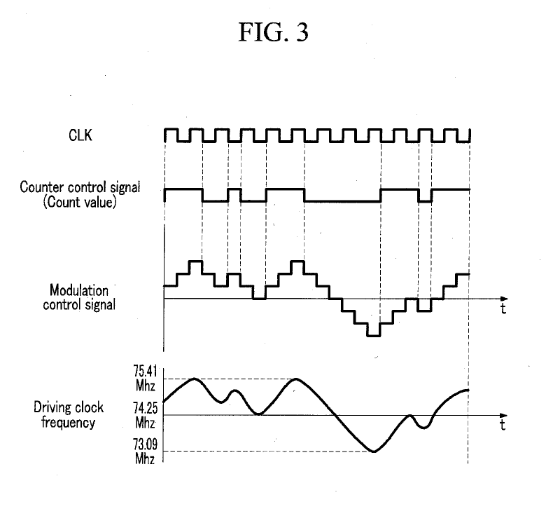

With reference to FIG. 3, a maximum value and a minimum value of count values provided from the switching counter 152 to the up/down counter 151 is changed randomly by the switching counter modulation circuit 153. That is, the count values may change irregularly, e.g.: 3, 2, 1, 2, 3, 6, 3, 1, and 3.

In detail, if up-counting starts, the up/down counter 151 starts up-counting at a first clock to count clocks three times. Next, the up/down counter 151 is switched to down-counting at a fourth clock to count clocks twice. Then, the up/down counter 151 is switched to up-counting at a sixth clock to count clocks once, and is switched to down-counting again at a seventh clock to count clocks twice. Further, the up/down counter 151 is switched to up-counting at a ninth clock to count clocks three times. Thereafter, the period changes, rather than being changed by the same period. Namely, the up/down counter 151 is switched to down-counting at a twelfth clock to count clocks six times, and is switched to up-counting at a seventeenth clock to count clocks three times.

In this manner the count value, namely the counter control signal, provided to the up/down counter 151 from the switching counter 152, is changed in irregular or non-periodic fashion, by the switching counter modulation circuit 153.

Because the up/down counter 151 outputs modulation control signals according to counter control signals that change irregularly, these modulation control signals are also irregularly generated. The modulation unit 150 generates a spread spectrum modulation voltage according to the modulation control signal received from the modulation control circuit 15, and the clock generating unit 110 generates a spread spectrum clock according to the spread spectrum modulation voltage received from the modulation unit 150. This allows the spread spectrum clock generator 100 to modulate the frequency of the spread spectrum clock in an “irregular” or non-periodic manner. Here, the spread spectrum clock is a driving clock. FIG. 3 shows an example of the driving clock.

One of ordinary skill in the art will realize that a variable resistor circuit may be used as the switching counter modulation circuit 153. The variable resistor circuit may have various structures within the scope that those of ordinary skill in the art can design.

In this manner, the counter control signals, namely, the count values, may be irregularly changed by the switching counter modulation circuit 153. For example, the maximum value, the minimum value, and the size of the period of the counter control signal may be randomly determined.

With such configuration, the spread spectrum clock generator 100 can reduce electromagnetic interference (EMI) by simply and effectively reducing the frequency at which certain EMI-generating, undesirable events occur. For example, the above described methods can reduce the number of times that the modulated clock, namely, the spread spectrum clock, overlaps with another frequency to cause an error.

### Exemplary Embodiment 2

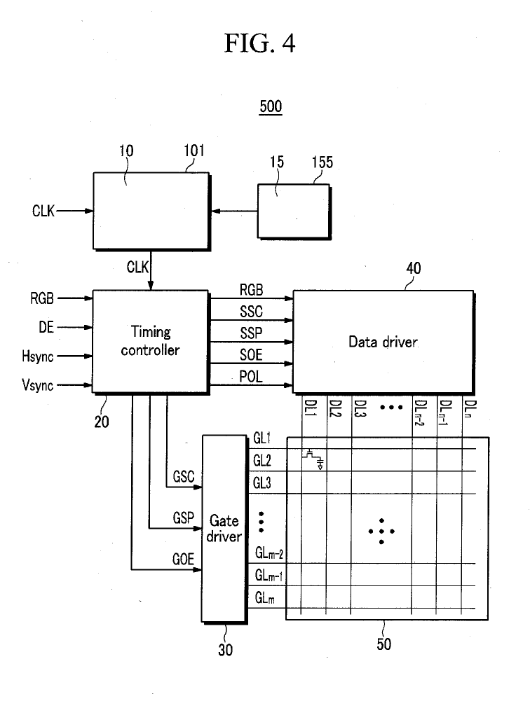

FIG. 4 is a schematic block diagram of a display device 500 according to a second exemplary embodiment of the present invention. As shown in FIG. 4, a display device 500 includes a spread spectrum integrated circuit (SSIC) 101, a modulation controller 155, a timing controller 20, a data driver 40, a gate driver 30, and a display panel 50. The spread spectrum IC chip 101 includes a spread spectrum clock generating circuit 10, and the modulation controller 155 includes a modulation control circuit 15.

The timing controller 20 receives a spread spectrum clock (clock obtained by modulating a reference clock) from the spread spectrum clock generating circuit 10, and supplies driving signals to the gate driver 30 and the data driver 40. The gate driver 30 and the data driver 40 receive the driving signals from the timing controller 20 and transfer them to the display panel 50.

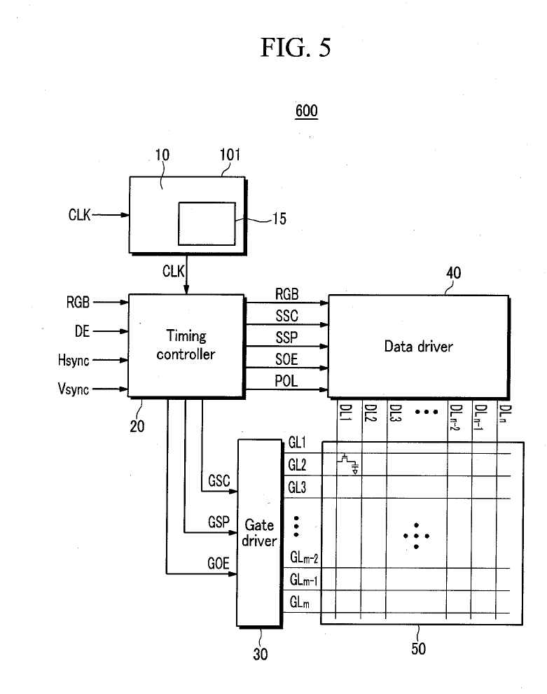

The display panel 50 displays an image according to the driving signals received from the gate driver 30 and the data driver 40. The display panel 50 shown in FIG. 5 is a liquid crystal panel, but the present invention is not limited thereto.

As the display device 500 employs a spread spectrum clock generating circuit 10 configured as above, it operates with fewer EMI-generating events. For example, as above, the display device 500 operates with fewer errors due to overlap between the modulated clock and other frequencies such as the charge time period of pixels, or other driving frequencies.

### Exemplary Embodiment 3

FIG. 5 is a schematic block diagram of a display device 600 according to a third exemplary embodiment of the present invention. As shown in FIG. 5, a display device 600 includes the spread spectrum integrated circuit (SSIC) 101, the timing controller 20, the data driver 40, the gate driver 30, and the display panel 50.

The spread spectrum IC chip 101 includes the spread spectrum clock generating circuit 10 and the modulation control circuit 15. Namely, the modulation control circuit 15 is provided together with the spread spectrum clock generating circuit 10 in the spread spectrum IC chip 101.

As with the display device 500 above, display device 600 employs a spread spectrum clock generating circuit 10 configured as above. Thus, as above, it operates with fewer EMI-generating events. For example, as above, the display device 600 operates with fewer errors due to overlap between the modulated clock and other frequencies such as the charge time period of pixels, or other driving frequencies.

### Exemplary Embodiment 4

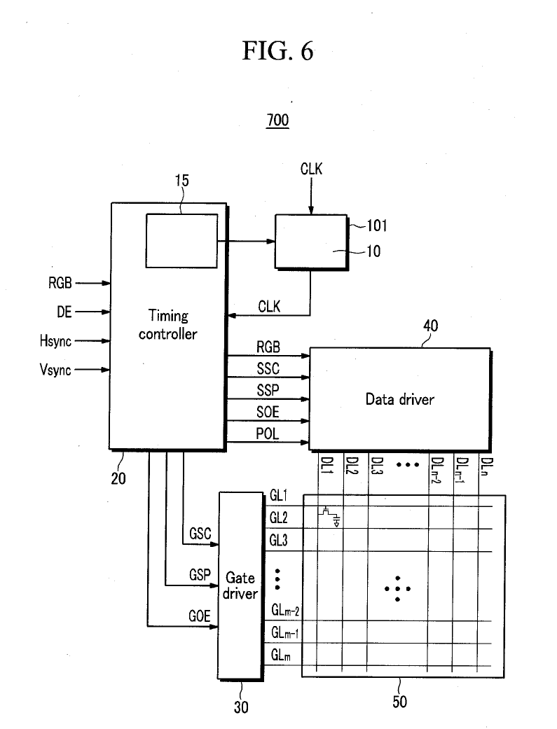

FIG. 6 is a schematic block diagram of a display device 700 according to a fourth exemplary embodiment of the present invention. As shown in FIG. 6, a display device 700 includes the spread spectrum integrated circuit (SSIC) 101, the timing controller 20, the data driver 40, the gate driver 30, and the display panel 50. The spread spectrum IC chip 101 includes the spread spectrum clock generating circuit 10.

The timing controller 20 includes modulation control circuit 15. It also receives the spread spectrum clock (obtained by modulating the reference clock) from the spread spectrum clock generating circuit 10, and supplies driving signals to the gate driver 30 and the data driver 40.

Here as above, the modulation control circuit 15 installed in the timing controller 20 supplies the modulation control signal to the spread spectrum clock generating circuit 10, and the spread spectrum clock is generated accordingly, so as to yield the above-described advantages.

According to the present invention, the spread spectrum clock generator can reduce electromagnetic interference (EMI) and effectively suppress errors that may be caused when the modulated clock overlaps with another frequency. In addition, display devices using the spread spectrum clock generator of the invention can effectively suppress errors that may be caused when the modulated clock overlaps with a charge time period of pixels or with a particular driving frequency.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A spread spectrum clock generator comprising:
a spread spectrum clock generating circuit that receives a reference clock and generates a spread spectrum clock; and
a modulation control circuit that provides a modulation control signal to the spread spectrum clock generating circuit;
wherein a frequency of the spread spectrum clock is varied according to the modulation control signal.

2. The generator of claim 1, wherein the spread spectrum clock generating circuit comprises:
a modulation unit that generates a spread spectrum modulation voltage according to the modulation control signal; and
a clock generating unit that generates a spread spectrum clock according to the spread spectrum modulation voltage.

3. The generator of claim 1, wherein the modulation control circuit comprises:
an up/down counter that counts clocks;
a switching counter that provides a counter control signal to the up/down counter to control switching between an up-counting operation and a down-counting operation of the up/down counter; and
a switching counter modulation circuit that controls the switching counter so as to generate the counter control signal, the counter control signal being a non-periodic signal;
wherein the modulation control signal is generated according to the up-counting operations and the down-counting operations, the up-counting operations and the down-counting operations performed according to the counter control signal.

4. The generator of claim 3, wherein the counter control signal corresponds to a count value that is maintained until the up-down counter is switched from one of the up-counting operation and the down-counting operation to the other, and wherein the count value changes irregularly.

5. The generator of claim 3, wherein the counter control signal has a period having at least one of a maximum value, a minimum value, and a size, and wherein the switching counter modulation circuit varies at least one of the maximum value, the minimum value, and the size of the period.

6. The generator of claim 3, wherein the switching counter modulation circuit is a variable resistor circuit.

7. The generator of claim 3:
wherein the spread spectrum clock generating circuit comprises a modulation unit that generates a spread spectrum modulation voltage according to the modulation control signal, and a clock generating unit that generates a spread spectrum clock according to the spread spectrum modulation voltage;
the generator further comprising:
a phase comparing unit that detects a phase difference between the reference clock and the spread spectrum clock, and outputs a phase difference voltage proportional to the detected phase difference;
a loop filter that receives the output voltage of the phase comparing unit, filters the received output voltage, and outputs a filtered voltage; and
an adding circuit that adds the spread spectrum modulation voltage generated by the modulation unit to the filtered voltage output from the loop filter and supplies the resultant voltage to the clock generating unit.

8. The generator of claim 2, wherein the clock generating unit is a voltage controlled oscillator (VCO).

9. A display device comprising
a spread spectrum clock generator, the spread spectrum clock generator comprising:
a spread spectrum clock generating circuit that receives a reference clock and generates a spread spectrum clock; and
a modulation control circuit that provides a modulation control signal to the spread spectrum clock generating circuit,
wherein a frequency of the spread spectrum clock is varied according to the modulation control signal.

10. The device of claim 9, wherein the spread spectrum clock generating circuit comprises:
a modulation unit that generates a spread spectrum modulation voltage according to the modulation control signal; and
a clock generating unit that generates a spread spectrum clock according to the spread spectrum modulation voltage.

11. The device of claim 9, wherein the modulation control circuit comprises:
an up/down counter that counts clocks;
a switching counter that provides a counter control signal to the up/down counter to control switching between an up-counting operation and a down-counting operation of the up/down counter; and
a switching counter modulation circuit that controls the switching counter as to generate the counter control signal, the counter control signal being a non-periodic signal;
wherein the modulation control signal is generated according to the up-counting operations and the down-counting operations, the up-counting operations and the down-counting operations performed according to the counter control signal.

12. The device of claim 11, wherein the counter control signal corresponds to a count value that is maintained until the up/down counter is switched from one of the up-counting operation and the down-counting operation to the other, and wherein the counter value changes irregularly.

13. The device of claim 11, wherein the counter control signal has a period having at least one of a maximum value, a minimum value, and a size, and wherein the switching counter modulation circuit varies at least one of the maximum value, the minimum value, and the size of the period.

14. The device of claim 11, wherein the switching counter modulation circuit is a variable resistor circuit.

15. The device of claim 11,
wherein the spread spectrum clock generating circuit comprises a modulation unit that generates a spread spectrum modulation voltage according to the modulation control signal, and a clock generating unit that generates a spread spectrum clock according to the spread spectrum modulation voltage;
the generator further comprising:
a phase comparing unit that detects a phase difference between the reference clock and the spread spectrum clock and outputs a phase difference voltage proportional to the detected phase difference;
a loop filter that receives the output voltage of the phase comparing unit, filters the received output voltage, and outputs a filtered voltage; and
an adding circuit that adds the spread spectrum modulation voltage generated by the modulation unit to the filtered voltage output from the loop filter and supplies the resultant voltage to the clock generating unit.

16. The device of claim 10, wherein the clock generating unit is a voltage controlled oscillator (VCO).

17. The device of claim 9, further comprising:
a spread spectrum integrated circuit (SSIC) chip comprising the spread spectrum clock generating circuit;
a modulation controller comprising the modulation control circuit;
a timing controller receiving the spread spectrum clock from the spread spectrum clock generating circuit;
a data driver and a gate driver receiving driving signals from the timing controller; and
a display panel receiving the driving signals from the data driver and the gate driver so as to display an image.

18. The device of claim 9, further comprising:
an SSIC chip comprising the spread spectrum clock generating circuit and the modulation control circuit;
a timing controller receiving the spread spectrum clock from the spread spectrum clock generating circuit;
a data driver and a gate driver receiving driving signals from the timing controller; and
a display panel receiving the driving signals from the data driver and gate driver so as to display an image.

19. The device of claim 9, further comprising:
an SSIC chip comprising the spread spectrum clock generating circuit;
a timing controller comprising the modulation control circuit and receiving the spread spectrum clock from the spread spectrum clock generating circuit;
a data driver and a gate driver receiving driving signals from the timing controller; and
a display panel receiving the driving signals from the data driver and the gate driver so as to display an image.

20. A method of generating a spread spectrum clock, the method comprising:
generating an irregular counter control signal;
counting clocks according to the counter control signal so as to generate a modulation control signal; and
generating a spread spectrum clock according to the modulation control signal.

21. The method of claim 20, wherein the generating a spread spectrum clock further comprises:
generating a spread spectrum modulation voltage according to the modulation control signal; and
generating the spread spectrum clock according to the spread spectrum modulation voltage.

22. The method of claim 20, wherein the counter control signal refers to a count value that is maintained until the up/down counter is switched from one of the up-counting operation and the down-counting operation to the other, and wherein the count value changes irregularly.

23. The method of claim 22, wherein the counter control signal has a period having at least one of a maximum value, a minimum value, and a size, and wherein the switching counter modulation circuit changes at least one of the maximum value, the minimum value, and the size of the period.
